(19) United States
(12) Patent Application Publication
(10) Pub. No.: US 2008/0068347 A1
(43) Pub. Date: Mar. 20, 2008

(54) Display-input device, display-input method, and computer program product

(75) Inventor: Hiroshi Morohoshi, Kanagawa (JP)

Correspondence Address: HARNESS, DICKEY & PIERCE, P.L.C., P.O. BOX 8910, RESTON, VA, 20195, US

(73) Assignee: RICOH COMPANY, LIMITED

(21) Appl. No.: 11/898,561

(22) Filed: Sep. 13, 2007

(30) Foreign Application Priority Data
Sep. 19, 2006 (JP) 2006-253408

(51) Int. Cl. G06F 3/041

(52) U.S. Cl. 345/173

(57) ABSTRACT

A display-input device includes an input unit that receives touch input; a display unit that displays a screen including a symbol selectable to specify setting in response to the touch input; a position detecting unit that detects a position of the touch input on the input unit; a distance detecting unit that detects, upon the input unit receiving successive touch inputs, a distance between positions of the touch inputs; and a display controlling unit that controls display of the screen on the display unit based on the position and the distance.

### CROSS-REFERENCE TO RELATED APPLICATIONS

The present application claims priority to and incorporates by reference the entire contents of Japanese priority document, 2006-253408 filed in Japan on Sep. 19, 2006.

### BACKGROUND OF THE INVENTION

1. Field of the Invention

The present invention relates to a technology for displaying an image through touch input.

2. Description of the Related Art

Conventional digital cameras are disclosed in, for example, Japanese Patent Application Laid-open Nos. H06-067787 and 2003-186100. The conventional digital cameras have a liquid-crystal display and a display-input device located adjacent to the liquid-crystal display. The liquid-crystal display can be a thin-film transistor and the display-input device can be an electronic dial, one or more operating buttons, or a stick-like operating member. A user operates the display-input device with fingers while looking at the liquid-crystal display unit when setting a photography mode or a customized function.

In recent years, functions in compact information devices, including digital cameras, are becoming sophisticated and complicated. Combination of navigation keys such as arrow keys for switching menus and buttons for selecting an item from a menu are widely used for setting such sophisticated and complicated functions.

However, in the conventional techniques, sometimes it is necessary to operate the keys many times to select and set functions, which puts a lot of burden on the users. Particularly, when the user is to take a photograph with the help of a digital camera, the user needs to shift the menu by repeatedly operating the keys, so that the user sometimes loses the timing of shooting.

Day-by-day the compact information devices, such as the digital cameras, are being downsized further and further. On the contrary, the liquid crystal displays of the compact information devices are being made larger and larger for easy viewing by the user. As a result, there is less place for operating buttons and the like in the casing of the compact information device. Therefore, the operating buttons are downsized and are clustered together in a narrow space, which undermines operability of the device. Specifically, a user having thick (fat) fingers may perform an erroneous operation because the buttons are very small and clustered together.

Moreover, a mechanical portion with at least four touch points is necessary on the arrow key. Therefore, the arrow key develops defects such as wear and tear due to continuous use of the portion for a long period of time and defective contact.

### SUMMARY OF THE INVENTION

It is an object of the present invention to at least partially solve the problems in the conventional technology.

According to an aspect of the present invention, there is provided a display-input device that includes an input unit that receives touch input; a display unit that displays a screen including a symbol selectable to specify setting in response to the touch input; a position detecting unit that detects a position of the touch input on the input unit; a distance detecting unit that detects, upon the input unit receiving successive touch inputs, a distance between positions of the touch inputs; and a display controlling unit that controls display of the screen on the display unit based on the position and the distance.

According to another aspect of the present invention, there is provided a display-input method including receiving touch input; detecting a position of the touch input; detecting, upon receiving successive touch inputs at the receiving, a distance between positions of the touch inputs; and controlling display on a display unit based on the position and the distance.

According to still another aspect of the present invention, there is provided a computer program product comprising a computer usable medium having computer readable program codes embodied in the medium that, when executed, causes a computer to execute the above method.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a rear view of a digital camera to which is applied a display-input device according to an embodiment of the present invention;

FIG. 2 is an exploded perspective view of a touch-input unit shown in FIG. 1;

FIG. 3 is a cross section of the touch-input unit;

FIG. 4 is a block diagram of the digital camera;

FIG. 5 is a functional block diagram of a controlling unit (central processing unit) shown in FIG. 4;

FIG. 6 is a flowchart of a process procedure for touch-input display according to the embodiment; and

FIG. 7 is an example of a menu screen.

### DETAILED DESCRIPTION OF THE PREFERRED EMBODIMENTS

Exemplary embodiments of the present invention are explained in detail below with reference to the accompanying drawings. While the present invention is explained as being applied to an input unit and a display unit of a digital camera, it can be applied to various other devices that display information in response to input.

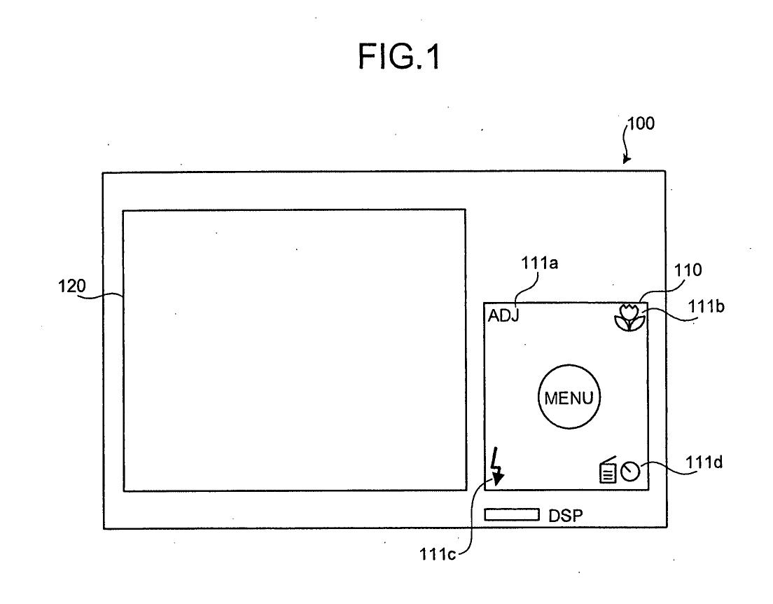

FIG. 1 is a rear view of a digital camera 100 according to an embodiment of the present invention. The digital camera 100 includes a liquid-crystal monitor (display unit) 120 and a touch-input unit (input unit) 110 on a rear side thereof.

The liquid-crystal monitor 120 displays a menu to specify settings and functions for an image captured by the digital camera 100. Moreover, the liquid-crystal monitor 120 displays an image captured by the digital camera 100. The liquid-crystal monitor 120 also displays, as symbols, menu items corresponding to the settings and the functions so that a user can select a desired item from the menu. The symbols include icons and images representing data and various functions that can be performed on the digital camera 100.

A user uses the touch-input unit 110 to input commands for displaying a menu and menu items, and to select an item or specifying parameters on the menu. The touch-input unit 110 is located at such a position that it can be operated with a right-hand thumb of the user when the user holds the digital camera in his hand. Thus, even a user having a thick thumb can use the digital camera with less operational errors. The user can input data by touching an input screen (electrostatic pad) of the touch-input unit 110 with a finger, or by using input devices such as a stylus pen.

The touch-input unit 110 includes four light emitting diodes (LED) 111 as lighting members, which are embedded in four corners of the touch-input unit 110. The four LEDs 111 each correspond to one of menu-option buttons 111a to 111d. In an example of FIG. 1, the menu-option button 111a (ADJ) in the top-left corner of the touch-input unit 110 corresponds to an adjust menu that displays on the liquid-crystal monitor 120 items available for the user. The menu-option button 111b in the top-right corner corresponds to a macro photography menu. The menu-option button 111c in the bottom-left corner corresponds to a flash menu, and the menu-option button 111d in the bottom-right corner corresponds to a timer menu.

When a “MENU” button at the center of the touch-input unit 110 is touched, and one of the menu-option buttons 111a to 111d is touched thereafter, a corresponding menu is displayed on the liquid-crystal monitor 120, and the LED 111 corresponding to a selected menu-option button is illuminated at the same time.

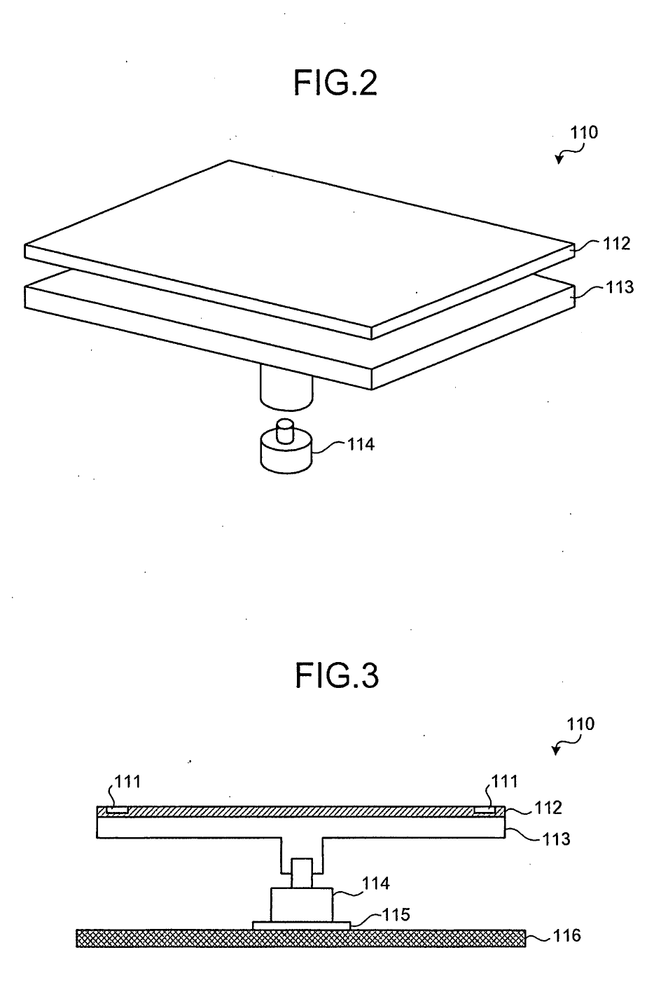

FIG. 2 is an exploded perspective view of the touch-input unit 110. FIG. 3 is a cross section of the touch-input unit 110. In the touch-input unit 110, a tactile switch 114 that passes through a sensor 115 is located on a substrate 116. The tactile switch 114 joins a supporting member 113 of the touch-input unit 110, and an electrostatic pad 112 is installed on the supporting member 113.

The electrostatic pad 112 forms the surface of the touch-input unit 110, and the menu-option buttons 111a to 111d are embedded in the electrostatic pad 112. When the user touches the surface of the electrostatic pad 112 the electrostatic pad 112 is pressed towards the substrate 116, and change occurs on the surface of the electrostatic pad 112. The electrostatic pad 112 detects change in electrostatic capacitance arising from touch on the surface, and outputs a first detecting signal that indicates position of the surface touched by the user and the change in electrostatic capacitance. The electrostatic pad 112 includes an electrode (not shown). The electrostatic pad 112 detects a position on the surface touched by a user and the change in electrostatic capacitance through the electrode, and outputs the first detecting signal indicating the position and the change in electrostatic capacitance. The electrode of the electrostatic pad 112 is connected to a controller, to be mentioned at a later stage, via an analog-to-digital (A/D) converter for transmitting the first detecting signal.

The tactile switch 114 detects a touch on any one of the menu-option buttons 111a to 111d or a touch on the “MENU” button (see FIG. 1). When the electrostatic pad 112 is touched, touch is transmitted through the supporting member 113 to the tactile switch 114. A terminal is embedded in a lower part of the tactile switch 114. When the electrostatic pad 112 is touched, the sensor 115 senses movement of the terminal, and outputs a second detecting signal to the controller, described later, to notify the controller that the electrostatic pad 112 is touched. The sensor 115 is connected to the controller via the A/D converter for sensing the movement of the terminal.

The controller senses whether the touch-input unit 110 is touched at the central part or at one of the four corners, through the second detecting signal and the first detecting signal that is output from the electrode of the electrostatic pad 112 (the signal indicating change in the position and the electrostatic capacitance).

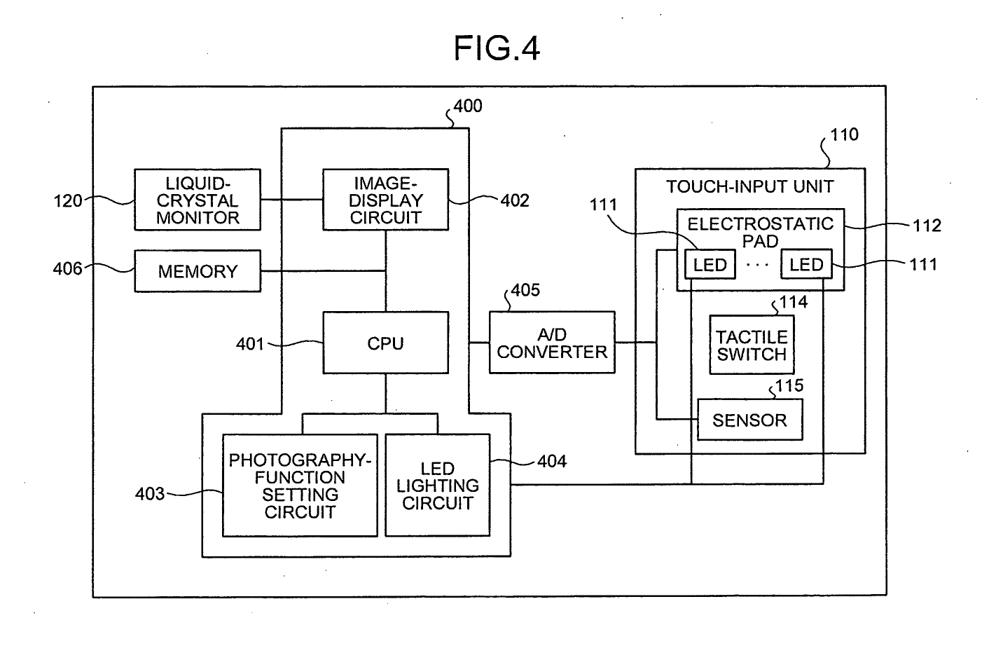

FIG. 4 is a block diagram of the digital camera 100. The touch-input unit 110 is connected to an A/D converter 405 that outputs digital signals by converting the first detecting signal and the second detecting signal from analogue to digital signals. The A/D converter 405 is connected to a controller 400. The four menu-option buttons 111a to 111d embedded in the electrostatic pad 112 of the touch-input unit 110 are directly connected to the controller 400.

The first detecting signal converted to digital signal after analogue to digital conversion is referred simply as a first detecting signal and the second detecting signal converted to digital signal after analogue to digital conversion is referred simply as a second detecting signal.

The controller 400 is also connected to the liquid-crystal monitor 120 and a memory 406, and includes an image-display circuit 402 that displays images, menus and the like on the liquid-crystal monitor 120, a photography-function setting circuit 403 that sets photography functions, an LED lighting circuit 404 that illuminates the LEDs 111, and a central processing unit (CPU) 401 that controls these circuits. The memory 406 stores therein computer programs for various settings and display control.

The CPU 401 reads the computer programs from the memory 406, and executes display-input processes such as an absolute-position detecting process, a distance detecting process, a speed detecting process, a display controlling process, and an LED-light controlling process.

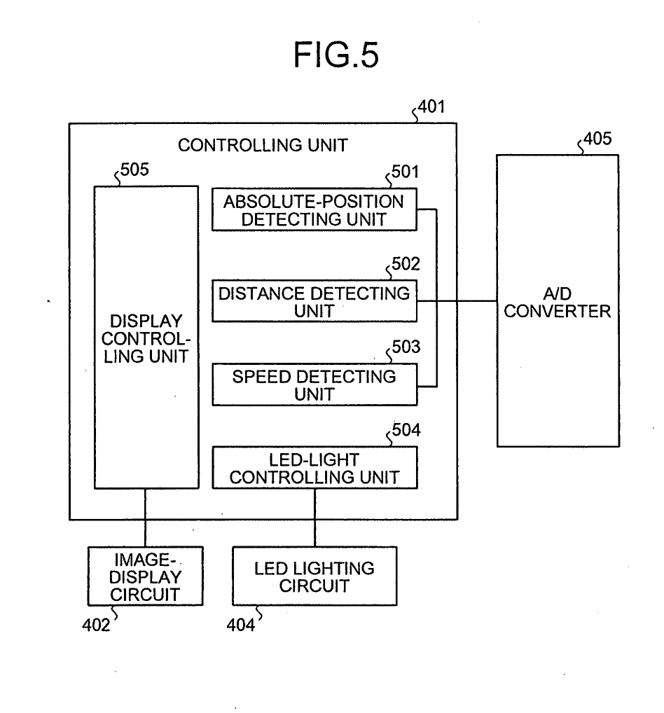

FIG. 5 is a functional block diagram of the CPU 401. The CPU 401 includes an absolute-position detecting unit 501, a distance detecting unit 502, a speed detecting unit 503, an LED-light controlling unit 504, and a display controlling unit 505.

When the electrostatic pad 112 is touched by a user, the absolute-position detecting unit 501 calculates the first detecting signal (the position of the touch on the surface of the electrostatic pad 112 and the change in electrostatic capacitance), the second detecting signal, and coordinate of a position of touch on the electrostatic pad 112. The absolute-position detecting unit 501 detects an absolute position from calculated coordinate.

The distance detecting unit 502 judges that the electrostatic pad 112 has been touched when the first detecting signal is continuously output. The distance detecting unit 502 calculates coordinates of respective positions that have been successively touched by the user from the positions touched on the surface of the electrostatic pad 112 and the change in electrostatic capacitance indicated by the first detecting signal. The distance detecting unit 502 calculates distance between the positions and direction from one position to another from the changes in the coordinates.

The speed detecting unit 503 judges that the electrostatic pad 112 is touched continuously when the first detecting signal is continuously output, and calculates coordinates of respective positions that are continuously touched from the position of the touch on the surface of the electrostatic pad 112 and the change in electrostatic capacitance indicated by the first detecting signal. The speed detecting unit 503 calculates speed and a direction of shift in the positions that are touched, from the shift and time of the shift of the coordinates.

The LED-light controlling unit 504 judges which one of the four menu-option buttons 111a to 111d is touched from the absolute position detected by the absolute position detecting unit 501, and controls illuminating of corresponding one of the four LEDs 111 by sending instructions to the LED lighting circuit 404 to illuminate the corresponding LED 111.

The display controlling unit 505 issues instructions to the image-display circuit 402 to display the menu screen or the symbols based on calculated absolute position, distance, direction, and speed of the shift, thus controlling display of the menu screen or the symbols on the liquid-crystal monitor 120.

Specifically, if the absolute position on the electrostatic pad 112 is one of the corners of the electrostatic pad 112, the display controlling unit 505 displays on the liquid-crystal monitor 120 the function setting menu corresponding to one of the menu-option buttons 111a to 111d embedded in one of the corners of the electrostatic pad 112. If the absolute position is at the center of the electrostatic pad 112, the display controlling unit 505 issues instructions to the image-display circuit 402 to display the menu screen on the liquid-crystal monitor 120.

The display controlling unit 505 issues instructions to the image-display circuit 402 to increase the amount of scroll such as increasing the number of pages scrolled of an image proportionate to detected distance. Furthermore, the display controlling unit 505 issues instructions to the image-display circuit 402 to increase the amount of scroll such as increasing the number of pages scrolled of an image proportionate to detected speed

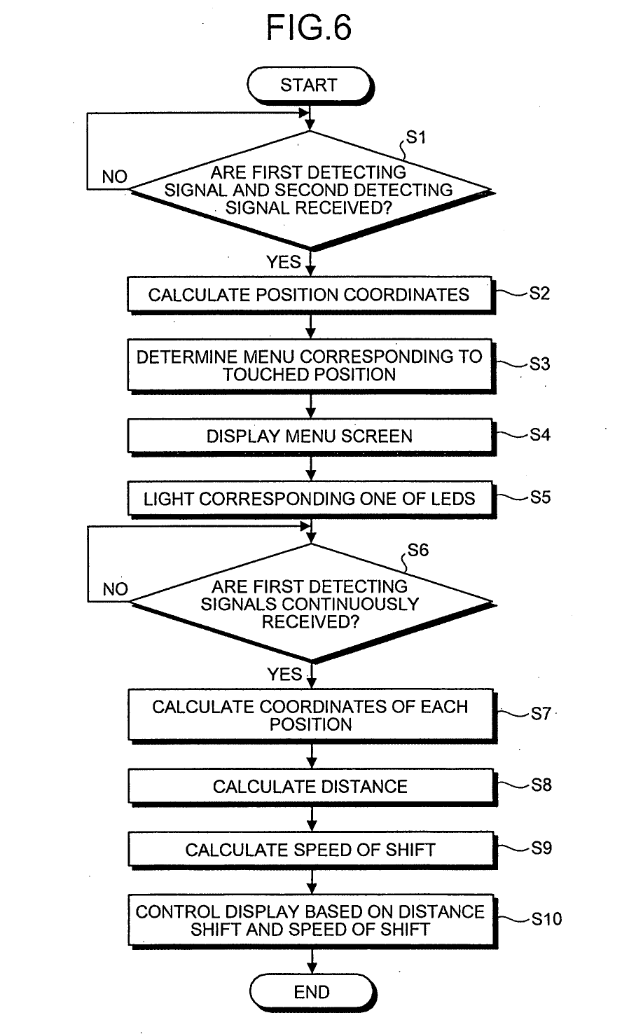

FIG. 6 is a flowchart of a process procedure for touch-input display in the digital camera according to the embodiment.

First, the absolute-position detecting unit 501 waits to receive the first detecting signal from the electrostatic pad 112 via the A/D converter 405 and the second detecting signal from the tactile switch 114 (step S1). When the first detecting signal and the second detecting signal are detected (Yes at step S1), the absolute position detecting unit 501 judges that the electrostatic pad 112 has been touched, and calculates coordinates of the respective position from the position of the touch on the surface of the electrostatic pad 112 and the change in electrostatic capacitance included in the first detecting signal (step S2).

Next, the display controlling unit 505 judges whether the touched position is any one of the four corners of the electrostatic pad 112 or the center of the electrostatic pad 112, and determines the menu corresponding to the touched position (step S3). The display controlling unit 505 sends an instruction to display menu screen of the menu and displays the menu screen on the liquid-crystal monitor 120 (step S4). If hold-down position is any one of the four corners of the electrostatic pad 112, the LED-light controlling unit 504 sends an instruction to the LED lighting circuit 404 to illuminate corresponding one of the LEDs 111 (step S5). Thus, the LED 111 corresponding to the touch position is illuminated.

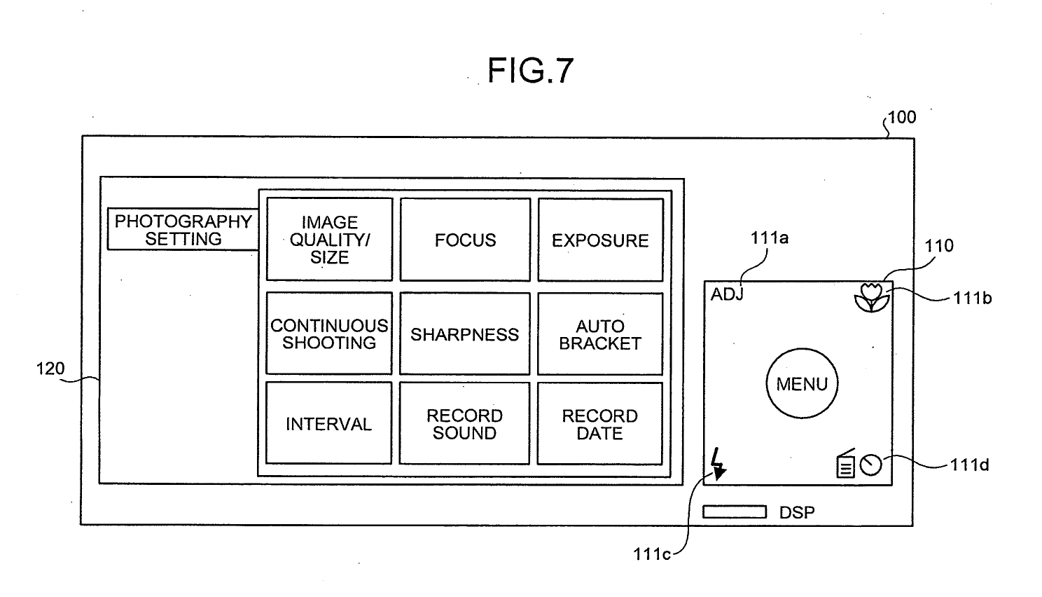

If the touch position is the center of the electrostatic pad 112, it is judged that “MENU” is selected and initial menu screen is displayed on the liquid-crystal monitor 120. If the touch position is the top-left corner of the electrostatic pad 112, it is judged that the menu-option button 111a, i.e., menu “ADJ”, is selected. The adjust menu is displayed on the liquid-crystal monitor 120, and the LED 111 corresponding to the menu-option button 111a or menu “ADJ” is illuminated. As shown in FIG. 7, the liquid-crystal monitor 120 displays a menu screen in which menu items are arranged in a square grid.

Thereafter, the distance detecting unit 502 and the speed detecting unit 503 wait for the first detecting signal (step S6). When the first detecting signals are continuously received (Yes at step S6), the distance detecting unit 502 and the speed detecting unit 503 judge that a user is shifting the touch position on the electrostatic pad 112, and calculates the coordinates of each of the touch positions at the point of time when the reception of the first detecting signal is started and at the point of time when the reception of the first detecting signal is stopped, i.e., the coordinates of each position during shifting or the coordinates of position when the shifting started and that of position when the shifting stopped (step S7). The distance detecting unit 502 calculates a distance between the positions touched by the user and a direction from one position to another from the coordinates calculated at the point of time of the start and at the point of time of end of the shift (step S8).

The speed detecting unit 503 calculates speed and the direction of shift in the positions by dividing distance, between the coordinates of the position at the point of time of the start and that of the position at the point of time of end of the shift, by the time from start to end of the shift (step S9).

The display controlling unit 505 controls display of symbols based on calculated distance shift and the speed of the shift (hereinafter, touch speed) (step S10).

The display controlling unit 505 instructs the image-display circuit 402 to increase the amount of scrolling proportionate to the detected size of the distance. The display controlling unit 505 instructs the image-display circuit 402 to increase the amount of scrolling proportionate to the detected touch speed.

Thus, in the digital camera 100, when the electrostatic pad 112 of the touch-input unit 110 is touched, the absolute position of the touched position is detected, and when the electrostatic pad 112 of the touch-input unit 110 is continuously touched, the distance between the touched positions and the touch speed is detected, and display of symbols on the liquid-crystal monitor 120 is controlled based on the absolute position and the distance between the touched positions. Thus, such a simple input operation improves the operability of the digital camera 100, and prolongs life of the device.

In the digital camera 100, illuminating of the menu-option buttons 111a to 111d, embedded in the electrostatic pad 112, is controlled based on the absolute position, which makes it clear that which one of them is selected by the user.

In the digital camera 100 according to the embodiment, the number of buttons and the like arranged on the exterior are reduced, which helps in clearing doubts that a beginner may have regarding complicated operation of the digital camera 100.

In the digital camera 100, the number of portions such as buttons can be reduced, which reduces the cost of manufacturing, and wear and tear and friction among the portions. This results in prolonging the life of the device and improving reliability of the device.

A computer program (hereinafter, “display-input process program”) executed by the digital camera 100 can be stored in the memory 406, a read only memory (ROM), and the like to be provided.

The display-input process program can also be stored in computer-readable recording media such as a flexible disk (FD), a compact disk-read (CD-R), and a digital versatile disk (DVD) in the form of an installable and executable file.

The display-input process program can also be stored on a computer connected to a network such as the Internet and distributed or downloaded via the network.

The display-input process program has modules implementing such functions as the absolute-position detecting unit 501, the distance detecting unit 502, the speed detecting unit 503, the LED-light controlling unit 504, and the display controlling unit 505. The display-input process program can be read and executed by the hardware such as the CPU 401 via the memory 406 or the ROM, and the respective units mentioned above can be loaded on to and realized by the main storing device.

In the embodiment, the present invention has been described with respect to a digital camera. However, the present invention can be applied to devices such as a mobile telephone, a portable music player, and a personal digital assistant that displays images and the like upon an input from a user.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A display-input device comprising:
an input unit that receives touch input;
a display unit that displays a screen including a symbol selectable to specify setting in response to the touch input;
a position detecting unit that detects a position of the touch input on the input unit;
a distance detecting unit that detects, upon the input unit receiving successive touch inputs, a distance between positions of the touch inputs; and
a display controlling unit that controls display of the screen on the display unit based on the position and the distance.

2. The display-input device according to claim 1, further comprising a speed detecting unit that detects, upon the input unit receiving successive touch inputs, a speed at which the touch inputs have been provided, wherein
the display controlling unit controls the display of the screen on the display unit based on the speed.

3. The display-input device according to claim 2, wherein the input unit includes
an electrostatic member that detects change in electrostatic capacitance resulting from touch input; and
a switch member that detects whether a touch input has occurred based on the change in electrostatic capacitance detected by the electrostatic member, wherein
the position detecting unit detects the position based on the touch input detected by the switch member,
the distance detecting unit detects the distance based on the change in electrostatic capacitance detected by the electrostatic member, and
the speed detecting unit detects the speed based on the change in electrostatic capacitance detected by the electrostatic member.

4. The display-input device according to claim 3, further comprising:
a lighting unit that is embedded in the electrostatic member; and
a light controlling unit that controls lighting of the lighting unit based on the position of the touch input.

5. The display-input device according to claim 1, wherein the input unit is located adjacent to a thumb of a user when the user holds the display-input device.

6. A display-input method comprising:
receiving touch input;
detecting a position of the touch input;
detecting, upon receiving successive touch inputs at the receiving, a distance between positions of the touch inputs; and
controlling display on a display unit based on the position and the distance.

7. A computer program product comprising a computer usable medium having computer readable program codes embodied in the medium that, when executed, causes a computer to execute:
receiving touch input;
detecting a position of the touch input;
detecting, upon receiving successive touch inputs at the receiving, a distance between positions of the touch inputs; and
controlling display on a display unit based on the position and the distance.
